(19) United States
(12) Patent Application Publication
(10) Pub. No.: US 2025/0319888 A1
(43) Pub. Date: Oct. 16, 2025

(54) Method and System for Activating a Safety-Relevant Function of a Vehicle

(71) Applicant: Robert Bosch GmbH, Stuttgart (DE)

(72) Inventors: Heiko Freienstein, Weil Der Stadt (DE); Peter Schneider, Holzgerlingen (DE)

(21) Appl. No.: 19/173,383

(22) Filed: Apr. 8, 2025

(30) Foreign Application Priority Data
Apr. 12, 2024 (DE) 10 2024 203 383.9

(51) Int. Cl. B60W 50/029; B60W 50/02

(52) U.S. Cl. CPC B60W 50/029; B60W 50/0205; B60W 2050/021

(57) ABSTRACT

A method and system for activating a safety-relevant function of a vehicle is disclosed. The vehicle and/or the system has n ASIL control devices, at least one control device to be monitored and a function control device.

This application claims priority under 35 U.S.C. § 119 to application no. DE 10 2024 203 383.9, filed on Apr. 12, 2024 in Germany, the disclosure of which is incorporated herein by reference in its entirety.

The disclosure relates to a method and system for activating a safety-relevant function of a vehicle.

### BACKGROUND

In the modern automotive industry, various control devices play a decisive role in the safety, performance and functionality of vehicles, for example robotic vehicles or motor vehicles, especially motor vehicles with functions for automation or partial automation of the driving task. These control devices implement a plurality of safety-relevant functions, which are often classified with an ASIL (Automotive Safety Integrity Level).

Control devices that implement safety-relevant functions, so-called ASIL control devices, are safeguarded by a series of elaborate internal measures aimed at detecting and controlling potential hardware or software errors. Specific safety objectives are implemented to prevent or control dangerous malfunctions in various vehicle systems such as the ESP system, the airbag system, the radar and video ADAS systems and the electronic power steering system. These safety objectives range from preventing faulty automated braking operations to ensuring that airbags are only deployed in crash scenarios.

The safety and integrity of these ASIL control devices are ensured by a plurality of safety measures that are integrated into the software and hardware, typically as safety-relevant monitoring functions implemented in software. In particular, the correct execution of safety-relevant software functions during runtime is checked by application-agnostic measures in the basic software and specialized hardware elements within the ASIL control devices. These measures include program flow checking, redundant computing with subsequent comparison of results, the use of checksums and error correction codes as well as the monitoring of compute resources and the runtime monitoring of individual software processes.

These ASIL control devices can also be understood as a “safe” computing unit, wherein a safe computing unit is understood to be a computing unit that has a comparatively high safety requirement level (e.g. ASIL-A/B/C/D) or that has a strong independence from a unit to be monitored, in particular such that potentially dangerous errors in the computing unit to be monitored do not simultaneously lead to dangerous malfunctions in the “safe” computing unit.

DE 10 2008 043 089 A1 discloses a method for monitoring the functionality of an electronic component, in which a variable relating to a driving state of the motor vehicle is supplied to the electronic component as an input signal and an output signal of the electronic component is forwarded to an electronic computing unit, in which this output signal is further processed using diverse software algorithms. The outputs of the diverse software algorithms are then compared with each other in a comparator.

It is a task of the disclosure to provide an improved method and/or a system for monitoring and/or activating a safety-relevant function of a vehicle.

The task is solved by a method according to the features set forth below. The task is solved by a system according to the features also set forth below.

### SUMMARY

According to a first aspect, a method for monitoring and/or activating and/or not activating a safety-relevant function of a vehicle is proposed, the vehicle having n ASIL control devices, at least one control device to be monitored (QM control device) and a function control device, wherein n≥2, the method including the steps of:
providing test and/or configuration data by a first of the n ASIL control devices to at least one other of the n−1 ASIL control devices and to the at least one control device;
processing the provided test and/or configuration data by the at least one control device to generate at least one diagnostic message;
providing the at least one generated diagnostic message at least to the first of the n ASIL control devices and the at least one other of the n−1 ASIL control devices by the at least one control device;
checking the at least one generated diagnostic message, in particular using the provided test and/or configuration data, via the first of the n ASIL control devices and the at least one other of the n−1 ASIL control devices to provide a test result;
providing at least one confirmation signal each via the first of the n ASIL control devices and the at least one other of the n−1 ASIL control devices to the function control device based on the test result;
checking, via the function control device, a receipt and a status of the respectively provided confirmation signal; and
transmitting user data of the at least one control device to the function control device and activating the safety-relevant function on the basis of the transmitted user data if all confirmation signals have been received and depending on the respective status of the respective test result, for example if the status of all provided confirmation signals is “OK”, or not activating the safety-relevant function on the basis of the transmitted user data if at least one confirmation signal has not been received or depending on the respective status of the respective test result, for example if the status of at least one of the provided confirmation signals is “not OK”.

The control device to be monitored, also known as a QM control device, is preferably a control device without safety guarantees regarding correct functioning. A function control device may also be designed as an ASIL control device at the same time and can therefore be part of a monitoring network. The function control device is preferably a device that uses data from the QM control device, for example to actively check safety-relevant functions, such as an automated driving function.

The test result may have a status of “OK/NOK”, for example. However, these are only examples of how a test result can be displayed. The test result can, for example, also take the form of a “error-free/error” status or more complex status information, such as more than two statuses, or combine several formats. For example, a test result could be: “OK since period X”; “not OK since period Y” or “not OK with regard to diagnosis 1; or ‘OK with regard to diagnosis 2’; or ‘OK with regard to diagnosis 3’; or ‘not OK with regard to diagnosis 4’; etc.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, a system for monitoring and/or activating and/or not activating a safety-relevant function of a vehicle is proposed, the system having n ASIL control devices, at least one control device to be monitored and a function control device, wherein n≥2, wherein a first of the n ASIL control devices is configured to provide test and/or configuration data to at least one other of the n−1 ASIL control devices and to the at least one control device; wherein the at least one control device is configured to process the provided test and/or configuration data to generate at least one diagnostic message; and to provide the at least one generated diagnostic message to at least the first of the n ASIL control devices and the at least one other of the n−1 ASIL control devices;
wherein the first of the n ASIL control devices (also ASIL-SG) and the at least one other of the n−1 ASIL control devices are each configured to check the at least one generated diagnostic message, in particular using the provided test and/or configuration data, to provide a test result, and each provide at least one confirmation signal to the function control device based on the test result;
wherein the function control device is configured to check a receipt and a status of the respectively provided confirmation signal;
wherein the at least one control device (also QM-SG) is configured to transmit user data to the function control device, and wherein the function control device is configured to activate the safety-relevant function on the basis of the transmitted user data if all confirmation signals have been received and depending on the respective status of the respective test result, for example, if a status of all the confirmation signals provided is “OK”, or not to activate the safety-relevant function on the basis of the user data transmitted if at least one confirmation signal has not been received or depending on the respective status of the respective test result, for example, if the status of at least one of the confirmation signals provided is “not OK”.

The explanations given for the method apply to the system accordingly. In this regard, any linguistic modifications of features formulated in terms of the method can be reformulated for the system in accordance with standard linguistic practice, without such formulations having to be explicitly listed here.

In a further aspect, a vehicle is disclosed which has at least one such system. The vehicle may be a passenger car (passenger vehicle), in particular a car designed for the transportation of persons, such as a sedan, a station wagon, an SUV, and/or a convertible. The vehicle can be a truck. Trucks are used to transport goods and come in a variety of sizes and configurations, including tractor-trailers, truck tarpaulins, dump trucks, tankers, etc. The vehicle can be a bus used to transport passengers on public or private routes and can have different capacitances, for example from a minibus to a (multi-) articulated bus. The vehicle can be a motorcycle, i.e. a two-wheeled vehicle operated by one or two people. The vehicle can be an e-bike. The vehicle can be a train or a rail vehicle. The vehicle can be an airplane or an aircraft designed to transport passengers and/or cargo by air. The vehicle can be a ship or a boat, generally a watercraft, such as sailboats, motorboats, cargo ships, cruise ships, ferries, etc., used for the transportation of people and/or goods over water. These are just examples of a variety of vehicles used in different regions of transportation.

The preferred vehicle, for example a robotic vehicle or a motor vehicle, has several ASIL (Automotive Safety Integrity Level) control devices that are relevant for safety. There are at least two such control devices. Furthermore, the vehicle comprises at least one QM control device, which has special features with regard to computing power (e.g. in a version as a particularly powerful high-performance compute control device) and/or costs (e.g. in a particularly cost-effective version). This control device receives test and configuration data from one of the ASIL control devices. The at least one control device processes the received data and generates at least one diagnostic message. The at least one generated diagnostic message is checked by the (preferably all or at least some of) the ASIL control devices to provide a test result. Based on the test results, the ASIL control devices provide confirmation signals. The test results are preferably generated per ASIL control device, i.e. each or at least a predetermined part of the ASIL control devices provides a test result, for example in the form of an “OK” status or a “not OK” status. The function control device checks the receipt and status of the confirmation signals provided. Based on the transmitted user data and/or the status of the confirmation signals, the function control device then preferably decides whether the safety-relevant functions should be activated or deactivated.

In the present case, the functional user data sent by the at least one QM-SG (e.g. “Brake” control command) is only used by the function control device (e.g. ESP system) for safety-relevant functions if the monitor ASIL-SG signals that the QM-SG is fault-free by way of a corresponding bus signal (“dead man's switch principle”).

It may be preferable to deliberately oversize the number of ASIL-SGs required as a minimum according to safety standards, e.g. at least 2× B (D) required according to safety standards, wherein the ASIL-SG is designed with 3× B (D). This results in several innovative advantages and additional functions. Such safety functions consist of the fact that ASIL-SG monitors designed in this way can receive updates during operation, which is necessary, for example, if new QM-SG and/or software functions to be monitored are added to the SG network. In addition, decomposed and/or redundant supervisor ASIL SGs can test each other for latent faults during operation. In particular, after a software update of an ASIL-SG monitor, the at least two other ASIL-SG monitors check whether errors (possibly temporarily simulated errors for test purposes) in the QM-SG to be monitored are detected and/or signaled reliably and/or in good time even after the software update. The monitoring ASIL-SGs can be tested using diagnostic messages, which can be answered by the monitored monitoring ASIL-SGs with a special signature value, for example, in order to ensure that an update previously installed on the monitoring ASIL-SG(s) is correct. Furthermore, in the event of a failure and/or passivation and/or deactivation of one of the n ASIL-SG monitors, a sufficient number of ASIL-SG monitors remain active so that the QM-SG to be monitored can continue to perform its safety-relevant functions.

A method is provided for the distributed monitoring of at least one QM-SG by a monitoring network of ASIL-SGs using special fault diagnosis messages. Several ASIL-SGs are already present in all current vehicle architectures, so that it is preferably only possible to implement the method in existing vehicle structures on the software side or supplemented by a minor change on the hardware side. This makes retrofitting possible. The procedure offers a mutual check and/or testing of the safety-relevant monitoring functions between several ASIL-SGs at runtime. This can be particularly advantageous after configuration changes, e.g. a software update or after integration of a new control device. The present method thus offers improved update capability of the ASIL-SG in the monitoring network, in particular also for safety-relevant functions. Furthermore, if the number and/or safety integrity level of the ASIL-SGs involved in monitoring is oversized (e.g. 3× B (D)), increased reliability during operation can be ensured through redundancies. Furthermore, the method can be used to output very compact fault diagnosis messages, which makes it possible to implement the method with few additional communication resources and/or bus signals. A resource-efficient check of the fault diagnosis messages can also be provided in the ASIL-SG, which is comparatively limited in terms of compute resources, making it easy to integrate into existing E/E architectures.

QM control devices can, for example, be designed as particularly powerful central and/or zone control devices, which themselves do not have direct access to safety-relevant actuators (e.g. servo motor in the electronic power steering system; hydraulic pumps in the ESP system), but provide their control commands via network or bus messages. In another implementation, central and/or zone ECUs can also perform the role of ASIL-SG and monitor QM-SGs.

The cross-control device safety concept enables more cost-effective implementation of monitoring on existing ASIL control devices (e.g. actuator and/or sensor control devices) in the vehicle architectures. To ensure that the safety-relevant functions are monitored cost-effectively, a safety concept is implemented that applies across the individual control devices. This means that existing ASIL control devices such as actuator or sensor control devices in the vehicle architecture can be used to carry out safety monitoring.

The distributed monitoring functions are preferably implemented by additional software functions and can be used on different QM-SGs without requiring special hardware or software (e.g. operating systems or middleware). In other words, the present safety concept envisages that the monitoring functions can be implemented on the QM-SG without additional hardware or special software. This ensures that the safety concept also remains valid for future changes to the QM-SG, such as hardware upgrades or software changes, without the need for recertification.

It is particularly preferred that the monitoring ASIL control devices in particular can also receive regular software updates while maintaining the safety integrity of the vehicle systems. During these updates, the monitoring of the QM-SG can be temporarily taken over by other ASIL control devices and/or a special “monitoring network” or “supervisor” network to minimize potential safety risks.

The present method makes it possible to check the “correct” execution of safety-relevant software functions in function control devices at runtime by creating diagnostic messages that are exchanged in a networked group of ASIL control devices. An advantageous combination of different safety mechanisms can be used to keep the sizes and number of diagnostic messages transmitted in the control device network low, while maintaining a high level of fault coverage. The method enables the monitoring of high-performance QM-SGs (i.e. SGs that do not themselves fulfill (A)SIL requirements with regard to fault diagnosis) by several (low-performance & low-cost) monitor ASIL-SGs. Monitoring is based on the principle of distributed diagnostic signals to identify transient, permanent and/or latent errors in the execution of application software.

The distributed integrity monitoring provided herein facilitates and reduces the cost of changes to the control device network for safety-relevant function processing chains, in particular during the lifetime of a vehicle, and thus facilitates the implementation of business models such as software- and/or hardware-based function upgrades and/or “function as a service” business models.

In a further aspect, the provision of the at least one generated diagnostic message further includes providing functional user data, in particular in the form of bus signals, by the at least one control device.

The control device generates at least one diagnostic message, which preferably comprises information about the status or functionality of the control device. In addition to the at least one diagnostic message, the control device preferably provides functional user data. This data is information that is relevant for the safety-relevant function execution. The functional user data is provided in particular in the form of bus signals. Bus signals are data that are transmitted via the vehicle bus and allow different components, in this case the control devices, of the vehicle to communicate with each other. The control device is preferably responsible for providing both the diagnostic messages and the functional user data. This data is crucial for monitoring and controlling safety-relevant functions in the vehicle.

In a further aspect, checking includes matching the at least one generated diagnostic message with the test and/or configuration data, wherein the checking is successful if the at least one generated diagnostic message and the test and/or configuration data fulfill at least one test criterion.

Preferably, the diagnostic messages generated by the control device are checked. The check involves comparing the generated diagnostic messages with the test data and/or preferably comprises configuration data. This data preferably serves as a reference for the expected state or the expected conditions. The check is considered successful if the generated diagnostic message and/or the test and/or configuration data fulfill at least one test criterion. This means that the generated diagnostic message matches the expectations defined in the test and/or configuration data.

In a further aspect, if at least one confirmation signal has not been received or depending on the status of the test result, for example if at least one of the provided confirmation signals is “not OK”, an error elimination and/or error correction is initiated.

By way of example only, if at least one confirmation signal has not been received or the status of at least one of the provided confirmation signals is classified as “not OK”, an error elimination and/or error correction is preferably initiated. The system preferably recognizes that an error has occurred if the expected confirmation signals are not received or if, for example, the status of one or more signals is set to “not OK”. Following error detection, action is then preferably taken to rectify or correct the error. This may include reconfiguring, restarting or otherwise repairing the affected system to ensure the safety and functionality of the vehicle. Initiating error elimination and/or error correction is preferably done automatically by the system, semi-automatically or manually by a user as soon as the defined conditions for an error are present.

In a further aspect, at least two ASIL control devices are assigned to the at least one control device, wherein the at least two ASIL control devices, in particular together with the at least one control device, form a monitoring network in order to monitor the at least one control device.

Preferably, there is at least one control device that plays a central role in monitoring and controlling safety-relevant functions in the vehicle. At least two ASIL control devices are assigned to the control device. ASIL stands for Automotive Safety Integrity Level and characterizes the safety integrity of control devices in the vehicle in accordance with the ISO 26262 standards. The assigned ASIL control devices preferably form a monitoring network together with the control device. This means that these control devices preferably work in close cooperation to ensure the safety and integrity of the system. The monitoring network is preferably responsible for monitoring safety-relevant functions in the QM control device, providing test and/or configuration data, evaluating diagnostic information derived from this, detecting faults and, if necessary, initiating error elimination measures. Preferably, the safety load is therefore decomposed into a number of monitor ASIL-SGs, preferably at least two monitor ASIL-SGs. Together, these form a monitoring network and check the diagnostic messages provided by the QM-SG for potential (runtime) errors.

In a further aspect, in the case of an update of the first of the n ASIL control devices, the functions of the first of the n ASIL control devices are taken over by at least another of the n−1 ASIL control devices until the update is finished and/or a testing of the updated/modified first of the n ASIL control devices is completed.

If an update or modification is carried out for the first of the n ASIL control devices that monitors the safety functions in the vehicle, it is preferred if the first of the n ASIL control devices is operational again for monitoring when the update or modification is completed and/or the updated/modified first of the n ASIL control devices has been successfully tested and is therefore operational again for the safety check. During the update or modification process, at least one other of the n−1 ASIL control devices takes over the functions of the updated/modified control device. This ensures the continuity and safety of the functions in the vehicle, even if the first of the n ASIL control devices is temporarily unavailable. The functions taken over from the updated/modified ASIL control device are preferably taken over by the other control device until the update or modification has been completed and/or at least one test, which can be multi-stage, of the first of the n ASIL control devices has been successfully performed. The temporary takeover of the functions by another control device ensures that the safety and integrity of the vehicle is maintained during the update process.

In a further aspect, the testing includes exchanging diagnostic messages between the updated/modified first one of the n ASIL control devices and the at least one further one of the n−1 ASIL control devices for checking the plausibility of the behavior of the updated/modified first one of the n ASIL control devices and/or testing temporarily simulated errors.

After the first of the n ASIL control devices has been updated/modified, a test process is carried out to ensure that the updated control device functions properly and fully meets the safety requirements with regard to its monitoring functions in the monitoring network. During the test process, an exchange of diagnostic messages preferably takes place between the updated/modified first of the n ASIL control devices and at least one other of the n−1 ASIL control devices. This exchange is preferably used to check the correctness and plausibility of the information, in particular the confirmation signals, generated by the updated control device. The exchange of diagnostic messages is used to check the plausibility of the information generated by the updated first of the n ASIL control devices. This is a step in the test process to ensure that the updated ASIL control device is functioning properly and providing reliable information. The test process with the exchange of diagnostic messages aims to ensure that the updated control device performs its functions properly, i.e. in particular that potential faults in the monitored QM control device are reliably diagnosed and signaled by the updated ASIL control device even after the update, and that the safety of the vehicle is not impaired by the update.

The “temporarily simulated errors” can, for example, be generated by an ASIL control device in order to provoke or cause a monitoring reaction of the most recently updated ASIL control device in order to test this ASIL control device in this way.

In a further aspect, after successful testing, the updated/modified first of the n ASIL control devices is reconfigured to the functional position that was assigned to the first of the n ASIL control devices before the update or change.

For example, the first of the n ASIL control devices is updated/modified to potentially add new features, fix bugs or improve performance. After the update/modification, the updated control device undergoes a testing process to ensure that it works properly and meets safety standards. After successful testing, the updated or modified control device is reconfigured back to the functional position that was assigned to the first of the n ASIL control devices before the update/modification. This means that the control device is restored to its original configuration, settings and functions. The reconfiguration ensures that the continuity of the functions in the vehicle is guaranteed. The vehicle can continue to be operated safely after the update, as the updated/modified control device retains its previous functions and settings.

In a further aspect, a computer program comprising program code is disclosed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and further developments can be combined with one another as desired.

Further possible embodiments, refinements, and implementations of the disclosure also comprise not explicitly mentioned combinations of features of the disclosure described above or below with respect to exemplary embodiments.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

The figures show:

FIG. 1 a schematic flowchart of one aspect of the method;

FIG. 2 a schematic flowchart of a further aspect of the method;

FIG. 3 a schematic block diagram of one aspect of the system; and

FIG. 4 a schematic block diagram of a further aspect of the system.

### DETAILED DESCRIPTION

In the figures of the drawings, identical reference numerals denote identical or functionally identical elements, parts or components, unless stated otherwise.

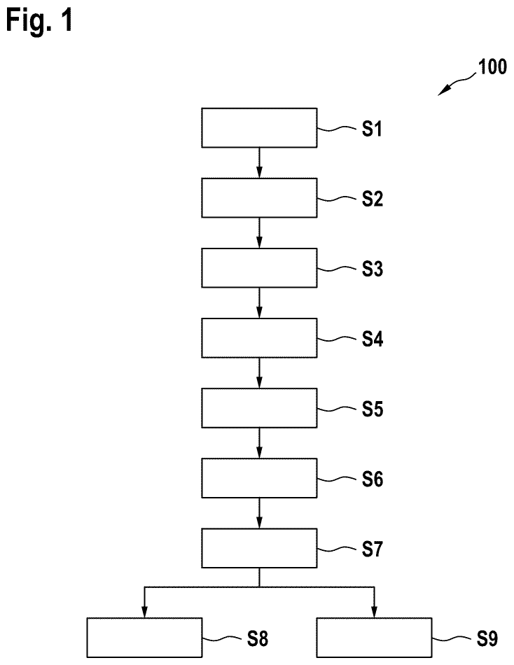

FIG. 1 shows a schematic flowchart of a procedure for activating a safety-relevant function of a vehicle. FIG. 1 shows a flowchart of a distributed diagnosis for a control device that generates user data for a function control device and is monitored by n ASIL control devices.

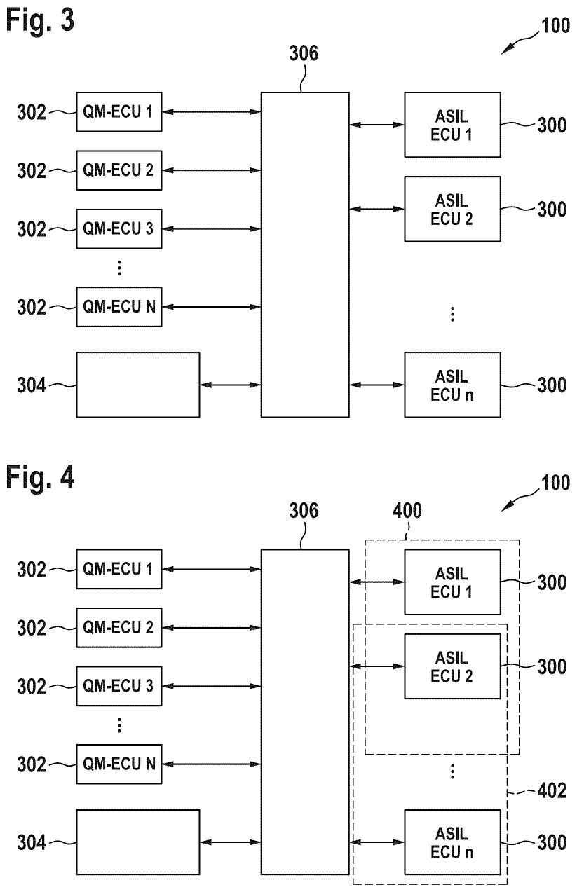

The vehicle, which itself is not shown in detail, has a number of n ASIL control devices 300, at least one control device 302 to be monitored and a function control device 304 (see FIG. 3). The number n is preferably greater than or equal to two (n≥2)

In any embodiment, the method may be implemented at least in part by a system 100.

The computer-implemented method comprises at least the following steps:

In a step S1, a providing of test and/or configuration data by a first one of the n ASIL control devices to at least another one of the n−1 ASIL control devices and to the at least one control device.

In a step S2, the test and/or configuration data provided is processed by the at least one control device to generate at least one diagnostic message.

In a step S3, the at least one generated diagnostic message is provided at least to the first of the n ASIL control devices and the at least one other of the n−1 ASIL control devices by the at least one control device.

In a step S4, the at least one generated diagnostic message is checked via the first of the n ASIL control devices and the at least one other of the n−1 ASIL control devices to provide a test result, for example an “OK” test result or a “not OK” test result.

In a step S5, at least one confirmation signal is provided to the function control device via the first of the n ASIL control devices and the at least one other of the n−1 ASIL control devices on the basis of the test result.

In a step S6, a receipt and a status of the respectively provided confirmation signal are checked via the function control device.

In a step S7, user data of the at least one control device is transmitted to the function control device and the safety-relevant function is activated S8 on the basis of the transmitted user data if all confirmation signals have been received and depending on the respective status of the respective test result, for example if the status of all the confirmation signals provided is “OK”, or not activating S9 the safety-relevant function on the basis of the user data transmitted if at least one confirmation signal has not been received or depending on the status of the respective test result, for example if the status of at least one of the confirmation signals provided is “not OK”.

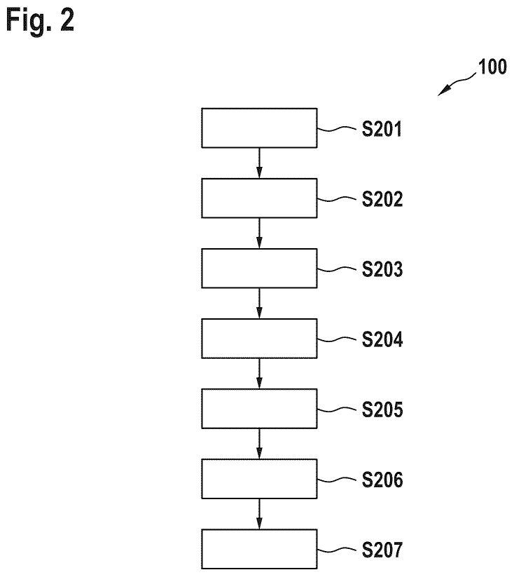

FIG. 2 shows an aspect of the method, in one case of an update/modification of the first of the n ASIL control devices 300.

Prior to the update, S200, of the first of the n ASIL control devices 300, a functional position for monitoring a performance and/or a function of the at least one control device 302 is assigned to this control device, possibly together with at least one further of the n−1 ASIL control devices 300, by exchanging and evaluating the diagnostic messages.

In preparation for the update, S202, the functions or the functional position of the first of the n ASIL control devices 300 are taken over by at least one other of the n−1 ASIL control devices until the update/modification is finished and/or a test of the updated/modified first of the n ASIL control devices 300 is completed. This means that the first of the n ASIL control devices 300 is released from its functional position for the update.

Thus, the monitoring of a performance and/or a function of the at least one control device 302 by exchanging and evaluating the diagnostic messages is then taken over by the at least one other of the n−1 ASIL control devices 300, which is indicated by S204.

The update is carried out in step S206.

After the update/modification of the first of the n ASIL control devices 300, testing is performed in S208 by exchanging diagnostic messages between the updated/modified first of the n ASIL control devices 300 and the at least one other of the n−1 ASIL control devices 300 to check the plausibility of correct operation of the updated/modified first of the n ASIL control devices 300.

In a second test phase, in S210, testing is performed by exchanging diagnostic messages between the updated/modified first one of the n ASIL control devices 300 and the at least one control device 302 and checking the exchanged diagnostic messages via the at least one other of the n−1 ASIL control devices 300.

In S212, after successful testing S208, S210, the updated/modified first of the n ASIL control devices 300 is reconfigured to the original functional position (see step S200) that was assigned to the first of the n ASIL control devices 300 before the update/modification.

FIG. 3 shows an aspect of the system 100. The system 100 has a plurality of ASIL control devices 300 (also ASIL ECUs 1-N in FIG. 3). The system 100 further comprises a plurality of control devices 302 (also QM-ECUs 1-N in FIG. 3) and a function control device 304 (also receiver ECU). The ASIL control devices 300 are connected to the control devices 302 and the function control device 304 via a data bus 306 for data exchange. Data is exchanged via the data bus 306.

FIG. 4 shows an aspect of the method and/or the system 100, in which at least two of the n ASIL control devices 300 can be combined as a monitoring network 400, 402 in order to enable uninterrupted monitoring of the at least one control device 302. In this case, at least two of the n ASIL control devices 300 are assigned to the at least one control device 302, which in particular together with the at least one control device form a monitoring network in order to monitor the at least one control device.

What is claimed is:

1. A method for activating a safety-relevant function of a vehicle, the vehicle having n ASIL control devices, at least one control device to be monitored, and a function control device, wherein n≥2, the method comprising:
providing test and/or configuration data by a first of the n ASIL control devices to at least one other of the n−1 ASIL control devices and to the at least one control device;
processing the provided test and/or configuration data by the at least one control device to generate at least one diagnostic message;
providing the at least one generated diagnostic message at least to the first of the n ASIL control devices and the at least one other of the n−1 ASIL control devices by the at least one control device;
checking the at least one generated diagnostic message, using the provided test and/or configuration data, via the first of the n ASIL control devices and the at least one other of the n−1 ASIL control devices to provide a test result;
providing at least one confirmation signal each via the first of the n ASIL control devices and the at least one other of the n−1 ASIL control devices to the function control device based on the test result;
checking, via the function control device, a receipt and a status of the respectively provided confirmation signal; and
transmitting user data of the at least one control device to the function control device; and
activating the safety-relevant function based on the transmitted user data when all confirmation signals have been received and depending on the status of the respective test result, or
not activating of the safety-relevant function based on the transmitted user data if at least one confirmation signal has not been received or depending on the status of the respective test result.

2. The method according to claim 1, wherein providing the at least one generated diagnostic message further includes providing functional user data, in the form of bus signals, by the at least one control device.

3. The method according to claim 1, wherein checking the at least one diagnostic message includes matching the at least one generated diagnostic message with the test and/or configuration data, and wherein the checking is successful if the at least one generated diagnostic message and the test and/or configuration data fulfill at least one test criterion.

4. The method according to claim 1, wherein, if at least one confirmation signal has not been received or depending on the respective status of the respective test result and/or the respective status of at least one of the provided confirmation signals, an error elimination and/or error correction is initiated.

5. The method according to claim 1, wherein at least two of the n ASIL control devices are assigned to the at least one control device, and wherein the at least two ASIL control devices, together with the at least one control device, form a monitoring network in order to monitor the at least one control device.

6. The method according to claim 1, wherein in case of an update and/or a change of the first of the n ASIL control devices, the functions of the first of the n ASIL control devices are taken over by at least one further of the n−1 ASIL control devices until the update/modification is finished and/or a testing of the updated or changed first of the n ASIL control devices is completed.

7. The method according to claim 6, wherein the testing includes exchanging diagnostic messages between the updated/modified first one of the n ASIL control devices and the at least one further one of the n−1 ASIL control devices for checking the plausibility of the behavior of the updated/modified first one of the n ASIL control devices.

8. The method according to claim 6, wherein the testing includes exchanging diagnostic messages between the updated/modified first one of the n ASIL control devices and the at least one control device and checking the exchanged diagnostic messages via the at least one other of the n−1 ASIL control devices and/or testing temporarily simulated errors.

9. The method according to claim 6, wherein the updated/modified first one of the n ASIL control devices is reconfigured after successful testing back to the functional position that was assigned to the first one of the n ASIL control devices before the update/modification.

10. A computer program having program code to execute at least portions of a method according to claim 1 if the computer program is executed on a computer.

11. A computer-readable data carrier having program code of a computer program to execute at least portions of a method according to claim 1 if the computer program is executed on a computer.

12. A system for activating a safety-relevant function of a vehicle, the system having n ASIL control devices, at least one control device to be monitored, and a function control device, wherein n≥2, and further:
wherein a first of the n ASIL control devices is configured to provide test and/or configuration data to at least one other of the n−1 ASIL control devices and to the at least one control device;
wherein the at least one control device is configured to process the provided test and/or configuration data to generate at least one diagnostic message; and to provide the at least one generated diagnostic message to at least the first of the n ASIL control devices and the at least one other of the n−1 ASIL control devices;
wherein the first of the n ASIL control devices and the at least one other of the n−1 ASIL control devices are each configured to check the at least one generated diagnostic message, using the provided test and/or configuration data, to provide a test result, and each provide at least one confirmation signal to the function control device based on the test result;
wherein the function control device is configured to check a receipt and a status of the respectively provided confirmation signal;
wherein the at least one control device is configured to transmit user data to the function control device, and
wherein the function control device is configured to:
activate the safety-relevant function on the basis of the transmitted user data when all confirmation signals have been received and depending on the status of the respective test result, or
not to activate the safety-relevant function based on the transmitted user data if at least one confirmation signal has not been received or depending on the status of the respective test result.
